(19) United States
(12) Patent Application Publication
(10) Pub. No.: US 2003/0043182 A1
(43) Pub. Date: Mar. 6, 2003

(54) Computer kiosk

(76) Inventor: William S. Kroll, Houston, TX (US)

Correspondence Address: Mark R. Wisner, c/o Wisner & Associates, Suite 930, 2925 Briarpark, Houston, TX, 77042, US

(21) Appl. No.: 09/946,412

(22) Filed: Sep. 5, 2001

(51) Int. Cl. G06F 17/60; G09G 5/00

(52) U.S. Cl. 345/719; 705/1

(57) ABSTRACT

A computer kiosk comprises a transparent housing, for the display of materials having an open front and back side, and contains within a chassis assembly composed of a touch-sensitive display screen affixed to a single-board computer and mounted to a back plate. The back plate attaches the transparent housing to the chassis assembly such that the touch-sensitive display screen is accessible from the open front side of the transparent housing, encloses the open back side of the transparent housing, and provides a back support for mounting the computer kiosk to a fixture.

### BACKGROUND OF THE INVENTION

This invention generally relates to computer kiosks. A computer kiosk is a computer system or terminal, including a display unit, typically constructed as a free-standing module or as a module that is mounted to a stand, wall, or other existing structure. The computer in such a kiosk is, for example, used by banks or other businesses to provide access to information about products to customers or to allow customers to perform transactions. Computer kiosks are also commonly used as building directories in large office buildings and retail shopping malls. Examples of other uses include multimedia presentations, at point of sales as cash registers in businesses, at industrial work stations to control machinery, and in special education situations to provide compliance with the Americans with Disabilities Act, 1990. Common to most computer kiosks are a display and an integral computer system. Typically, they employ a touch-sensitive display screen that allows the user to interact with the computer simply by touching areas on the screen without a keyboard, mouse, or other peripheral device. The kiosk may also include a printer for printing out product information or a record of a transaction. The kiosk may also include a telephone to allow the user to speak to a human advisor or access other information (for instance, from audible menus). Other accessories may include a speaker for audio communication, a card reader to scan a credit, debit, access cards, or smart cards, a wireless keyboard for data entry, or network links to provide access to the Internet or to other computer networks.

Such kiosks must have a user-friendly appearance so that their appearance does not discourage their use by persons who are not experienced in the use of computers. Nevertheless, the kiosk must be robust in construction, and for that reason, they tend to be bulky, which may make it difficult for the kiosk to fit in visually with its surroundings. For example, a kiosk may be built into a furniture-like unit, including a desktop in which the display screen is set substantially horizontally. Other mounting arrangements include affixing the kiosk to (or into) a wall or to a pole or stand to set the display screen substantially vertical.

With these many aesthetic and functional considerations in mind, it is a primary object of the present invention to provide a novel, more flexible and aesthetically attractive configuration for a computer kiosk.

Another object of the present invention is to provide a computer kiosk having a small “footprint” with a weather resistant, tamper-proof modular case that makes the computer kiosk ideal for public information access systems in spaces not suited to the traditional bulky and robust kiosk systems.

Another object of the present invention is to provide a computer kiosk that may be set free-standing on a counter or desktop to create an instant information system or alternatively the back side of the computer kiosk contains mounting arrangements of a type known in the art for attaching the computer kiosk to industry-standard arms, stands, wall-mounts, or vertical pole systems.

Another object of the present invention is to provide a computer kiosk of such size, weight, and dimension as to be usable with a laptop computer or even to allow it to be hand-held.

Another object of the present invention is to provide ease of serviceability by providing a computer kiosk case that opens with a single key to allow a technician access to drives and components.

Yet another object of the present invention is to provide a computer kiosk that includes a tamper-resistant, clear housing having an integral bezel for the display of materials, thereby eliminating the annoying and unattractive dead space surrounding the display screen of prior known kiosks and providing display space for materials inserted into the clear housing, including, for example, instructional materials for the use and operation of the computer kiosk, information related to other businesses services and/or other product lines of the company, paid advertisements, decorations, or transparencies of the above referenced materials.

Another object of the present invention is to provide a computer kiosk with a unique chassis assembly comprised of a (1) touch-screen display, (2) computer, (3) back plate, and (4) composite chassis that provides a unique support system for all components of the chassis assembly, thereby providing for semi-custom and economically feasible construction of the present invention.

### SUMMARY OF THE INVENTION

These objects, and the advantages of the computer kiosk of the present invention, are met by providing a computer kiosk with a transparent housing having an open front and an open back. A rear plate frame is attached to the inner surface of the transparent housing and to the back plate to hold a chassis assembly in place. The chassis assembly includes a touch-screen display having a rear housing fastened to a composite chassis. A book size, single-board computer using full-size components is mounted to the composite chassis, which in turn is fastened to the back plate that serves as a spine for supporting the other components. The back plate is provided with an integral VESA 100×100 mm bolt pattern and cam locks for mounting the assembled kiosk to a wall or other structure. The entire chassis assembly is housed within the transparent housing and attached to the rear plate frame by means of the back plate such that the touch-screen display is accessible from the open front of the transparent housing. The kiosk may be free-standing or mounted to a desired fixture using the back plate containing the integral VESA 100×100 mm bolt pattern and cam. Optionally, the back side of the back plate may be covered by a rear appearance housing plate when the computer kiosk is free-standing on a desktop mounted or when the back of the computer kiosk is otherwise visible.

### BRIEF DESCRIPTION OF THE DRAWINGS

FIG. 1 is an exploded, perspective view of the components of a preferred embodiment of a computer kiosk constructed in accordance with the teachings of the present invention.

### DESCRIPTION OF THE PREFERRED EMBODIMENT

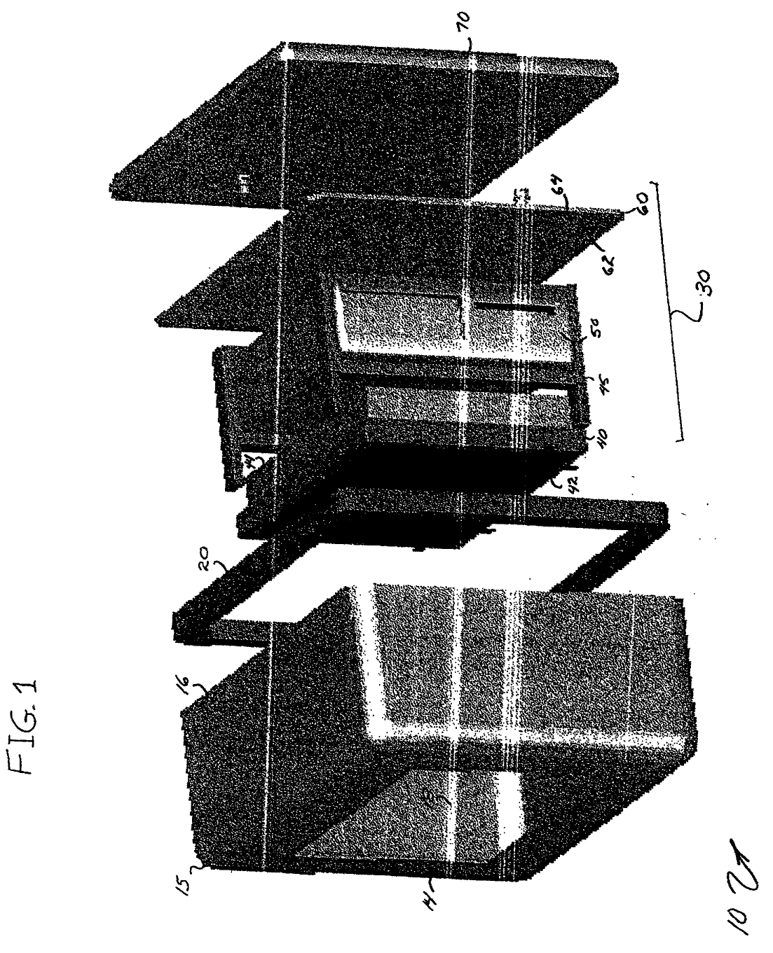

In this description of the preferred embodiments of the present invention, a computer kiosk for public input and output information systems is described. Referring to FIG. 1, a preferred embodiment of the computer kiosk of the present invention is indicated generally at reference numeral 10 and includes a transparent housing 12 having an open front 14 with integral bezel 15, a open back side 16, and interior side walls 18. The housing 12 is configured with a box shape, and is preferably molded of clear transparent polycarbonate in a unitary fashion. It is preferred that housing 12 be comprised of a transparent material such as polycarbonate, Plexiglass, or glass so that materials (such as signs, printed matter, and other two- and even three-dimensional displays) mounted inside the housing 12 are visible to those using the kiosk 10. A rear plate frame 20 is affixed within, and to the interior side walls 18 of housing 12 proximal to the open back side 16 of the transparent housing 12.

A chassis assembly 30 comprised of touchscreen display 40, book-sized, single-board computer 50, back plate 60, and frame 45 is assembled to the back plate 60 to provide a support system for the touchscreen display 40 and computer 50. The touchscreen display 40 of the present invention includes a screen side 42 that is accessible through the open front side 14 of transparent housing 12, and a rear side 44 configured generally flat to be engaged by the frame 45, with the computer 50 affixed to frame 45. The touchscreen display 40 (engaged to frame 45) and computer 50 (affixed to frame 45) are affixed to the front side 62 of the back plate 60 to form chassis assembly 30

In the preferred embodiment of the invention, the touchscreen display 40 is a standard Americans with Disabilities Act compliant, touch-sensitive display screen system such as is available under the brand name EZSCREEN™ (ezscreen, Houston, Tex.). In the preferred embodiment of the invention, the frame 45 is comprised of riveted or extruded aluminum channel that is configured into a box-frame shape. In a second preferred embodiment, the frame 45 is molded of modified urethane resin in a unitary fashion.

The front side 62 of the back plate 60 attaches mechanically to the rear plate frame 20 affixed within transparent housing 12 to secure transparent housing 12 to the entire chassis assembly 30, thereby enclosing the touchscreen display 40, single-board computer 50, and frame 45 within the computer kiosk 10. The back plate 60 contains an integral VESA 100×100 mm bolt pattern and cam lock (not shown) for mounting to a wall or other similar structure, and preferably is made of aluminum. For serviceability, the computer kiosk opens with a single key entry (not shown) for ease of a technician's access to drives and components. As will be evident to those skilled in the art from the description of the preferred embodiment of the invention, other support systems for holding the touchscreen display 40 and computer 50 to each other, and to back plate 60 to form the assembly chassis 30, include straps, clamps, bolts, screws, and VELCRO®.

The computer kiosk 10 optionally includes a rear appearance housing plate 70 attached to and covering the back side 64 of the back plate 60 for use when the computer kiosk 10 is desktop mounted or when the computer kiosk 10 is otherwise visible from all sides. The housing plate 70 is generally square-shaped and is preferably molded of clear polycarbonate in a unitary fashion. However, it will be evident to those skilled in the art from this description of the preferred embodiment of the invention that the housing plate 70 may be molded of any suitable plastic or metal material. In one particularly preferred embodiment, housing plate 70 is formed of a transparent material through which inserted materials are displayed in the same manner as described above in connection with the description of transparent housing 12.

As also will be evident to those skilled in the art from this description of the preferred embodiment of the invention, the materials to be inserted into housing 12, and optionally into the housing plate 70, may include, for example, instructional materials for the use and operation of the computer kiosk, information related to businesses, services and/or other product lines of the company in which the kiosk is located, advertisements, or even simple decorations or transparencies. In another embodiment of the computer kiosk 10 of the present invention, the transparent housing 12 and housing plate 70 include an electroluminescent or other backlight system for inserted transparencies.

In another embodiment of the computer kiosk 10 of the present invention, the computer kiosk 10 includes a speaker system.

In another embodiment of the computer kiosk 10 of the present invention, the computer kiosk 10 includes a printer for printing out product information or a record of a transaction.

In another embodiment of the computer kiosk 10 of the present invention, the computer kiosk 10 includes a telephone to allow a customer to speak to a human advisor.

In another embodiment of the computer kiosk 10 of the present invention, the computer kiosk 10 includes a card reader to scan a credit, debit, access, or similar-type card, and/or a smart card reader for scanning a smart card.

In another embodiment of the computer kiosk 10 of the present invention, the computer kiosk 10 includes a wireless keyboard for data entry.

In still another embodiment of the computer kiosk 10 of the present invention, the computer kiosk 10 includes a network link to provide access to the Internet or to an intra- or extranet.

As also will be evident to those skilled in the art from this description of the preferred embodiment of the invention, the frame 45 can be adapted to provide a support mechanism for a speaker system, telephone, printer, card or smart card scanner, keyboard, or other peripheral device integral to the computer kiosk 10.

The foregoing description of the preferred embodiment of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

What is claimed is:

1. A computer kiosk, comprising:
a transparent housing having an open front side and an open back side;
a rear plate frame affixed to said transparent housing;
a chassis assembly retained within said transparent housing comprising a means for supporting a touchscreen display and a computer; and
a back plate having a front side and a back side, said front side of said back plate affixed to said support means and said rear plate frame for enclosing within said transparent housing, said chassis assembly such that said touchscreen display is accessible from said open front side of said transparent housing.

2. The computer kiosk of claim 1 wherein a rear appearance housing plate is affixed to said back side of said back plate.

3. The computer kiosk of claim 1 wherein said transparent housing comprises a material selected from the group consisting of polycarbonate, Plexiglass, and glass.

4. The computer kiosk of claim 1 wherein said support means comprises a frame.

5. The computer kiosk of claim 1 wherein said back plate includes means for mounting said back plate, having said housing assembled thereto, to a support.

6. The computer kiosk of claim I further comprising at least one accessory component selected from the group consisting of an electroluminescent backlight system, a speaker system, a printer, a telephone, a card reader, a keyboard, and a network link.

7. A method of assembling a computer kiosk comprising the steps of:
fastening a touchscreen display and a single-board computer to a support means;
fastening said support means to a back plate;
inserting said touchscreen display, said single-board computer, and said support means into a transparent housing having an open front side and open back side; and
affixing said said transparent housing to said back plate to secure said touchscreen display, said single-board computer, and said support means therein with said touchscreen display accessible through said open front side of said transparent housing, and enclosing said back side of said transparent housing.
